(19) United States
(12) Patent Application Publication
(10) Pub. No.: US 2024/0429985 A1
(43) Pub. Date: Dec. 26, 2024

(54) METHOD AND DEVICE FOR TRANSMITTING AND RECEIVING CHANNEL STATE INFORMATION IN WIRELESS COMMUNICATION SYSTEM

(71) Applicant: LG Electronics Inc., Seoul (KR)

(72) Inventors: Yeongjun KIM, Seoul (KR); Sangrim LEE, Seoul (KR); Eunjong LEE, Seoul (KR); Hojae LEE, Seoul (KR)

(21) Appl. No.: 18/703,067

(22) PCT Filed: Oct. 20, 2021
(86) PCT No.: PCT/KR2021/014709

§ 371 Date: Apr. 19, 2024

(51) Int. Cl. H04B 7/06; H04W 24/02

(52) U.S. Cl. CPC H04B 7/0626; H04W 24/02

(57) ABSTRACT

A method, for transmitting channel state information, performed by a terminal in a wireless communication system according to one embodiment of the present specification comprises: a first step of receiving a reference signal associated with measurement of a channel; a second step of generating channel state information on the basis of the reference signal; a third step of transmitting the channel state information; and a fourth step of receiving a message comprising information determined on the basis of the channel state information.

### TECHNICAL FIELD

The present disclosure relates to a method and device for transmitting and receiving channel state information in a wireless communication system.

### BACKGROUND

Mobile communication systems have been developed to provide voice services, while ensuring activity of users. However, coverage of the mobile communication systems has been extended up to data services, as well as voice service, and currently, an explosive increase in traffic has caused shortage of resources, and since users expect relatively high-speed services, an advanced mobile communication system is required.

Requirements of a next-generation mobile communication system include accommodation of explosive data traffic, a significant increase in a transfer rate per user, accommodation of considerably increased number of connection devices, very low end-to-end latency, and high energy efficiency. To this end, there have been researched various technologies such as dual connectivity, massive multiple input multiple output (MIMO), in-band full duplex, non-orthogonal multiple access (NOMA), super wideband, device networking, and the like.

### DISCLOSURE

### Technical Problem

When Deep Learning (DL) for generating a Neural Network (NN) applied to wireless communication systems is performed through signaling between a user equipment (UE)/base station (e.g. Rx/Tx), a large overhead is required.

Considering the overhead issue, pre-learned NN parameters (e.g. NN parameters generated according to training through offline) can be used. At this time, the statistical characteristics of the channel may be considered so that elements related to the channel situation are reflected in the corresponding NN parameters.

However, if the statistical value of the channel considered in the procedure for generating NN parameters (e.g. offline training) are different from the statistical value of the real channel, domain shift occurs and system performance deteriorates.

The purpose of the present disclosure is to propose a method to solve the above-mentioned problems.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

A method of transmitting channel state information performed by a user equipment (UE) in a wireless communication system according to an embodiment of the present disclosure comprises a first step of receiving a reference signal related to measurement of a channel, a second step of generating channel state information based on the reference signal, a third step of transmitting the channel state information, and a fourth step of receiving a message including information determined based on the channel state information.

The channel state information includes at least one of 1) information related to a probability distribution based on the measurement of the channel or 2) information related to a difference between a probability distribution used for learning a neural network (NN) related to the wireless communication system and the probability distribution based on the measurement of the channel.

The information determined based on the channel state information includes a neural network (NN) parameter applied to the neural network.

A specific value related to update of the NN parameter may be determined by the probability distribution based on the measurement of the channel.

The specific value may be based on i) a difference between a probability distribution based on the measurement of the channel obtained based on a current time and a probability distribution based on the measurement of the channel previously obtained based on a previous time or ii) a difference between the probability distribution based on the measurement of the channel obtained based on the current time and an estimated value of a probability distribution related to the channel.

Based on the specific value being greater than or equal to a preconfigured value, the method may be performed again from any one of the first to third steps.

The information related to the probability distribution based on the measurement of the channel may include information related to at least one of i) received power of the reference signal or ii) a signal to noise ratio (SNR).

Based on the reference signal being related to a superimposed pilot signal transmitted in a same resource region as data, and a number of cases due to fading related to a resource region in which the reference signal is transmitted may be excluded from a number of cases related to the probability distribution based on the measurement of the channel.

The NN parameter may be related to configuration of at least one of an NN receiver or NN transmitter that operates based on a neural network (NN) related to the wireless communication system.

The method may further comprise receiving data based on the NN receiver to which the NN parameter is applied.

Based on information on the probability distribution used for learning the neural network (NN) related to the wireless communication system being preconfigured: 1) the information on the probability distribution used for learning the neural network (NN) related to the wireless communication system may include a preconfigured number of probability distributions, and 2) the channel state information may include one or more probability distributions among the preconfigured number of probability distributions.

A user equipment (UE) transmitting channel state information in a wireless communication system according to another embodiment of the present disclosure comprises one or more transceivers, one or more processors controlling the one or more transceivers, and one or more memories operably connected to the one or more processors, and storing instructions that configure the one or more processors to perform operations when being executed by the one or more processors.

The operations include a first step of receiving a reference signal related to measurement of a channel, a second step of generating channel state information based on the reference signal, a third step of transmitting the channel state information, and a fourth step of receiving a message including information determined based on the channel state information.

The channel state information includes at least one of 1) information related to a probability distribution based on the measurement of the channel or 2) information related to a difference between a probability distribution used for learning a neural network (NN) related to the wireless communication system and the probability distribution based on the measurement of the channel.

The information determined based on the channel state information includes a neural network (NN) parameter applied to the neural network.

An apparatus according to another embodiment of the present disclosure comprises one or more memories and one or more processors functionally connected to the one or more memories. The one or more memories store instructions that configure the one or more processors to perform operations when being executed by the one or more processors.

The operations include a first step of receiving a reference signal related to measurement of a channel, a second step of generating channel state information based on the reference signal, a third step of transmitting the channel state information, and a fourth step of receiving a message including information determined based on the channel state information.

The channel state information includes at least one of 1) information related to a probability distribution based on the measurement of the channel or 2) information related to a difference between a probability distribution used for learning a neural network (NN) related to the wireless communication system and the probability distribution based on the measurement of the channel.

The information determined based on the channel state information includes a neural network (NN) parameter applied to the neural network.

One or more non-transitory computer-readable medium according to another embodiment of the present disclosure store one or more instructions.

The one or more instructions configure the one or more processors to perform operations when being executed by the one or more processors.

The operations include a first step of receiving a reference signal related to measurement of a channel, a second step of generating channel state information based on the reference signal, a third step of transmitting the channel state information, and a fourth step of receiving a message including information determined based on the channel state information.

The channel state information includes at least one of 1) information related to a probability distribution based on the measurement of the channel or 2) information related to a difference between a probability distribution used for learning a neural network (NN) related to the wireless communication system and the probability distribution based on the measurement of the channel.

The information determined based on the channel state information includes a neural network (NN) parameter applied to the neural network.

A method of receiving channel state information performed by a base station in a wireless communication system according to another embodiment of the present disclosure comprises transmitting a reference signal related to measurement of a channel, receiving channel state information generated based on the reference signal, and transmitting a message including information determined based on the channel state information.

The channel state information includes at least one of 1) information related to a probability distribution based on the measurement of the channel or 2) information related to a difference between a probability distribution used for learning a neural network (NN) related to the wireless communication system and the probability distribution based on the measurement of the channel.

The information determined based on the channel state information includes a neural network (NN) parameter applied to the neural network.

A base station receiving channel state information in a wireless communication system according to another embodiment of the present disclosure comprises one or more transceivers, one or more processors controlling the one or more transceivers, and one or more memories operably connected to the one or more processors, and storing instructions that configure the one or more processors to perform operations when being executed by the one or more processors.

The operations include transmitting a reference signal related to measurement of a channel, receiving channel state information generated based on the reference signal, and transmitting a message including information determined based on the channel state information.

The channel state information includes at least one of 1) information related to a probability distribution based on the measurement of the channel or 2) information related to a difference between a probability distribution used for learning a neural network (NN) related to the wireless communication system and the probability distribution based on the measurement of the channel.

The information determined based on the channel state information includes a neural network (NN) parameter applied to the neural network.

### Advantageous Effects

According to an embodiment of the present disclosure, NN parameters may be determined adaptively to the current channel situation based on channel state information. Therefore, performance degradation of the communication system due to domain shift can be prevented. Furthermore, the reliability of a wireless communication system using a neural network (NN) can be improved.

According to an embodiment of the present disclosure, a reference signal for determining NN parameters applied to a wireless communication system can be transmitted from all resources through which data is transmitted based on a superimposed pilot system. When determining NN parameters, there is no need to consider the time/frequency fading characteristics of the channel according to the distribution of resources allocated to the reference signal. Accordingly, since the information that must be included in the channel state information is reduced, the signaling overhead of the procedure for determining NN parameters can be improved.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing a method of processing a transmitted signal applicable to the present disclosure.

FIG. 4 is a view showing another example of a wireless device applicable to the present disclosure.

FIG. 5 is a view showing an example of a hand-held device applicable to the present disclosure.

FIG. 6 is a view showing physical channels applicable to the present disclosure and a signal transmission method using the same.

FIG. 7 is a view showing the structure of a radio frame applicable to the present disclosure.

FIG. 8 is a view showing a slot structure applicable to the present disclosure.

FIG. 9 is a view showing an example of a communication structure providable in a 6G system applicable to the present disclosure.

FIG. 10A is a diagram for explaining a channel environment of wireless communication.

FIG. 10B is a diagram illustrating a channel frequency response in a channel environment of wireless communication.

FIG. 10C is a diagram for explaining selection of NN parameters using channel distribution according to an embodiment of the present disclosure.

FIG. 11 illustrates an OFDM system to which a superimposed pilot transmission method is applied.

FIG. 12 illustrates an OFDM system to which an orthogonal pilot transmission method is applied.

FIG. 13 is a diagram for explaining a procedure for measuring probability distribution of a channel according to an embodiment of the present disclosure.

FIG. 14 is a diagram for explaining NN parameters determined based on channel distribution measurement according to an embodiment of the present disclosure.

FIG. 15 is a flowchart showing an example of a procedure for configuring NN parameters according to an embodiment of the present disclosure.

FIG. 16 is a flowchart showing another example of a procedure for configuring NN parameters according to an embodiment of the present disclosure.

FIG. 17 is a flowchart showing another example of a procedure for configuring NN parameters according to an embodiment of the present disclosure.

FIG. 18 is a flowchart illustrating a method of transmitting channel state information performed by a user equipment (UE) according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”. “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an UpLink (UL). Likewise, the mobile station may serve as a receiver and the BS may serve as a transmitter, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

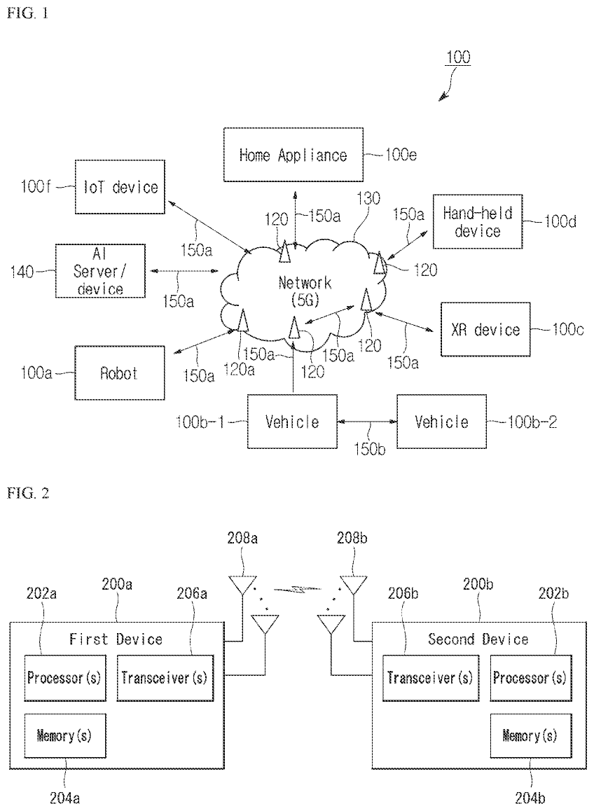

FIG. 1 is a view showing an example of a communication system applicable to the present disclosure. Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-l and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (JAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or (the wireless device 100x, the wireless device 100x) of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be connected with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be connected with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be connected with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be connected with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be connected with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be connected with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be connected with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be connected with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

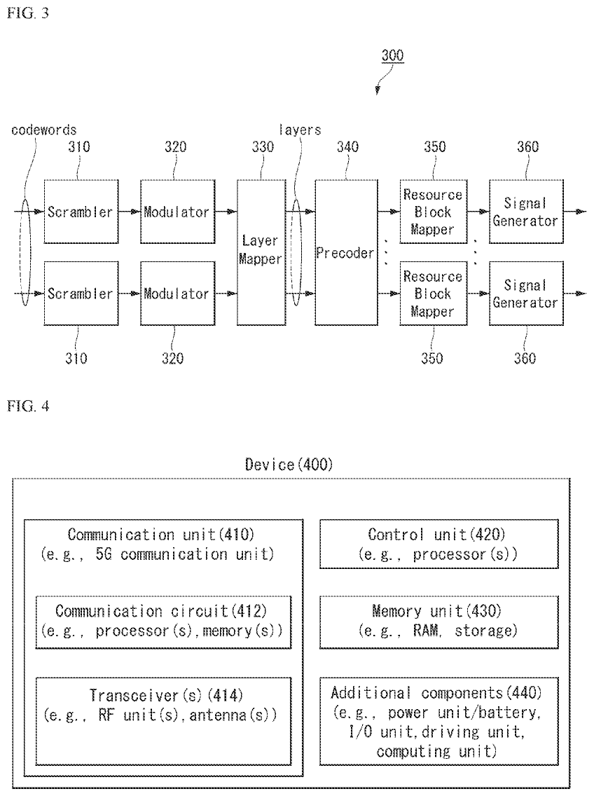

FIG. 3 is a view showing a method of processing a transmitted signal applicable to the present disclosure. For example, the transmitted signal may be processed by a signal processing circuit. At this time, a signal processing circuit 1200 may include a scrambler 300, a modulator 320, a layer mapper 330, a precoder 340, a resource mapper 350, and a signal generator 360. At this time, for example, the operation/function of FIG. 3 may be performed by the processors 202a and 202b and/or the transceiver 206a and 206b of FIG. 2. In addition, for example, the hardware element of FIG. 3 may be implemented in the processors 202a and 202b of FIG. 2 and/or the transceivers 206a and 206b of FIG. 2. In addition, for example blocks 310 to 350 may be implemented in the processors 202a and 202b of FIG. 2 and a block 360 may be implemented in the transceivers 206a and 206b of FIG. 2, without being limited to the above-described embodiments.

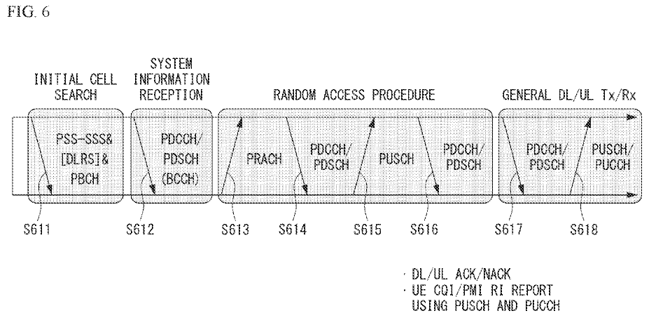

A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 6. Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 330. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### Structure of Wireless Device Applicable to the Present Disclosure

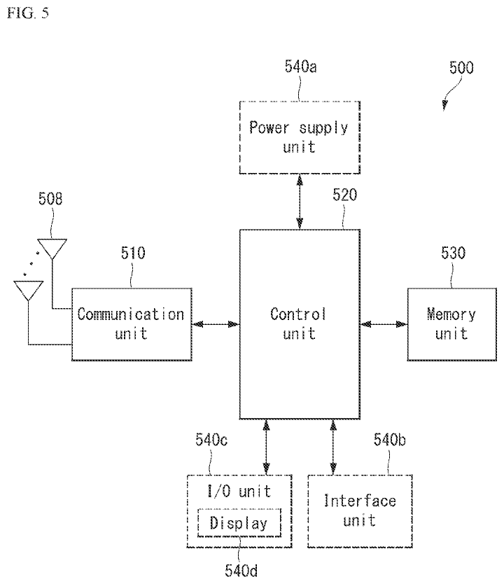

FIG. 4 is a view showing another example of a wireless device applicable to the present disclosure.

Referring to FIG. 4, a wireless device 400 may correspond to the wireless devices 200a and 200b of FIG. 2 and include various elements, components, units/portions and/or modules. For example, the wireless device 400 may include a communication unit 410, a control unit (controller) 420, a memory unit (memory) 430 and additional components 440. The communication unit may include a communication circuit 412 and a transceiver(s) 414. For example, the communication circuit 412 may include one or more processors 202a and 202b and/or one or more memories 204a and 204b of FIG. 2. For example, the transceiver(s) 414 may include one or more transceivers 206a and 206b and/or one or more antennas 208a and 208b of FIG. 2. The control unit 420 may be electrically connected with the communication unit 410, the memory unit 430 and the additional components 440 to control overall operation of the wireless device. For example, the control unit 320 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 or store information received from the outside (e.g., another communication device) through the wireless/wired interface using the communication unit 410 in the memory unit 430.

The additional components 440 may be variously configured according to the types of the wireless devices. For example, the additional components 440 may include at least one of a power unit/battery, an input/output unit, a driving unit or a computing unit. Without being limited thereto, the wireless device 400 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 4, various elements, components, units/portions and/or modules in the wireless device 400 may be connected with each other through wired interfaces or at least some thereof may be wirelessly connected through the communication unit 410. For example, in the wireless device 400, the control unit 420 and the communication unit 410 may be connected by wire, and the control unit 420 and the first unit (e.g., 130 or 140) may be wirelessly connected through the communication unit 410. In addition, each element, component, unit/portion and/or module of the wireless device 400 may further include one or more elements. For example, the control unit 420 may be composed of a set of one or more processors. For example, the control unit 420 may be composed of a set of a communication control processor, an application processor, an electronic control unit (ECU), a graphic processing processor, a memory control processor, etc. In another example, the memory unit 430 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 5 is a view showing an example of a hand-held device applicable to the present disclosure.

FIG. 5 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 5, the hand-held device 500 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/540a to 540c may correspond to the blocks 410 to 430/440 of FIG. 4, respectively.

The communication unit 510 may transmit and receive signals (e.g., data, control signals, etc.) to and from other wireless devices or base stations. The control unit 520 may control the components of the hand-held device 500 to perform various operations. The control unit 520 may include an application processor (AP). The memory unit 530 may store data/parameters/program/code/instructions necessary to drive the hand-held device 500. In addition, the memory unit 530 may store input/output data/information, etc. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 440c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

### Physical Channels and General Signal Transmission

In a radio access system, a UE receives information from a base station on a DL and transmits information to the base station on a UL. The information transmitted and received between the UE and the base station includes general data information and a variety of control information. There are many physical channels according to the types/usages of information transmitted and received between the base station and the UE.

FIG. 6 is a view showing physical channels applicable to the present disclosure and a signal transmission method using the same.

The UE which is turned on again in a state of being turned off or has newly entered a cell performs initial cell search operation in step S611 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. Meanwhile, the UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S612, thereby acquiring more detailed system information.

Thereafter, the UE may perform a random access procedure such as steps S613 to S616 in order to complete access to the base station. To this end, the UE may transmit a preamble through a physical random access channel (PRACH) (S613) and receive a random access response (RAR) to the preamble through a physical downlink control channel and a physical downlink shared channel corresponding thereto (S614). The UE may transmit a physical uplink shared channel (PUSCH) using scheduling information in the RAR (S615) and perform a contention resolution procedure such as reception of a physical downlink control channel signal and a physical downlink shared channel signal corresponding thereto (S616).

The UE, which has performed the above-described procedures, may perform reception of a physical downlink control channel signal and/or a physical downlink shared channel signal (S617) and transmission of a physical uplink shared channel (PUSCH) signal and/or a physical uplink control channel (PUCCH) signal (S618) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

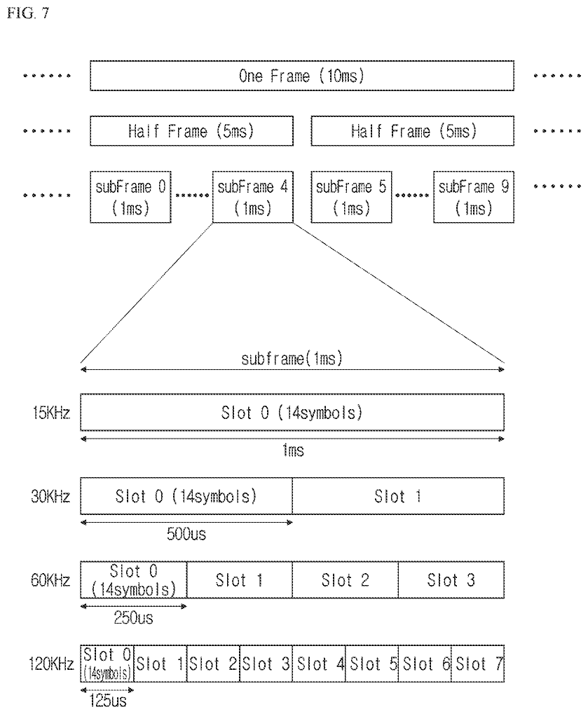

FIG. 7 is a view showing the structure of a radio frame applicable to the present disclosure.

UL and DL transmission based on an NR system may be based on the frame shown in FIG. 7. At this time, one radio frame has a length of 10 ms and may be defined as two 5-ms half-frames (HFs). One half-frame may be defined as five 1-ms subframes (SFs). One subframe may be divided into one or more slots and the number of slots in the subframe may depend on subscriber spacing (SCS). At this time, each slot may include 12 or 14 OFDM(A) symbols according to cyclic prefix (CP). If normal CP is used, each slot may include 14 symbols. If an extended CP is used, each slot may include 12 symbols. Here, the symbol may include an OFDM symbol (or a CP-OFDM symbol) and an SC-FDMA symbol (or a DFT-s-OFDM symbol).

Table 1 shows the number of symbols per slot according to SCS, the number of slots per frame and the number of slots per subframe when normal CP is used, and Table 2 shows the number of symbols per slot according to SCS, the number of slots per frame and the number of slots per subframe when extended CP is used.

TABLE 1

| μ | N_{symb}^{slot} | Nₛₗₒₜ^{frame,μ} | N_{słot}^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

TABLE 2

| μ | N_{symb}^{slot} | Nₛₗₒₜ^{frame,μ} | N_{słot}^{subframe,μ} |
|---|---|---|---|
| 2 | 12 | 40 | 4 |

In Tables 1 and 2 above, Nslotsymb may indicate the number of symbols in a slot, Nframe,μslot may indicate the number of slots in a frame, and Nsubframe,μslot may indicate the number of slots in a subframe.

In addition, in a system, to which the present disclosure is applicable, OFDM(A) numerology (e.g., SCS, CP length, etc.) may be differently set among a plurality of cells merged to one UE. Accordingly, an (absolute time) period of a time resource (e.g., an SF, a slot or a TTI) (for convenience, collectively referred to as a time unit (TU)) composed of the same number of symbols may be differently set between merged cells.

NR may support a plurality of numerologies (or subscriber spacings (SCSs)) supporting various 5G services. For example, a wide area in traditional cellular bands is supported when the SCS is 15 kHz, dense-urban, lower latency and wider carrier bandwidth are supported when the SCS is 30 kHz/60 kHz, and bandwidth greater than 24.25 GHz may be supported to overcome phase noise when the SCS is 60 kHz or higher.

An NR frequency band is defined as two types (FR1 and FR2) of frequency ranges. FR1 and FR2 may be configured as shown in the following table. In addition, FR2 may mean millimeter wave (mmW).

TABLE 3

| Frequency | Corresponding | Subcarrier |
|---|---|---|
| Range designation | frequency range | Spacing |
| FR1 | 410 MHz-7125 MHz | 15, 30, 60 kHz |
| FR2 | 24250 MHz-52600 MHz | 60, 120, 240 kHz |

In addition, for example, in a communication system, to which the present disclosure is applicable, the above-described numerology may be differently set. For example, a terahertz wave (THz) band may be used as a frequency band higher than FR2. In the THz band, the SCS may be set greater than that of the NR system, and the number of slots may be differently set, without being limited to the above-described embodiments. The THz band will be described below.

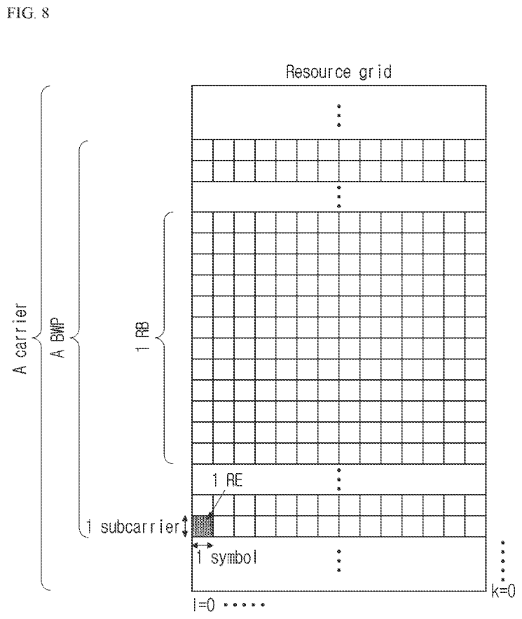

FIG. 8 is a view showing a slot structure applicable to the present disclosure.

One slot includes a plurality of symbols in the time domain. For example, one slot includes seven symbols in case of normal CP and one slot includes six symbols in case of extended CP. A carrier includes a plurality of subcarriers in the frequency domain. A resource block (RB) may be defined as a plurality (e.g., 12) of consecutive subcarriers in the frequency domain.

In addition, a bandwidth part (BWP) is defined as a plurality of consecutive (P)RBs in the frequency domain and may correspond to one numerology (e.g., SCS, CP length, etc.).

The carrier may include a maximum of N (e.g., five) BWPs. Data communication is performed through an activated BWP and only one BWP may be activated for one UE. In resource grid, each element is referred to as a resource element (RE) and one complex symbol may be mapped.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 4

| | |
|---|---|
| Per device peak data rate | 3 Tbps |
| E2E latency | 3 ms |
| Maximum spectral efficiency | 100 bps/Hz |
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

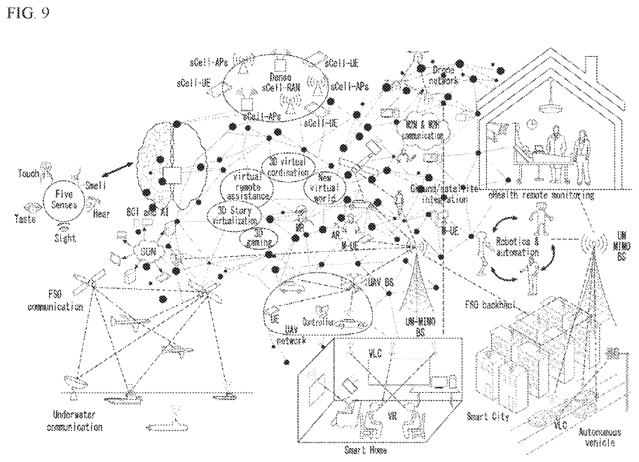

FIG. 9 is a view showing an example of a communication structure providable in a 6G system applicable to the present disclosure.

Referring to FIG. 9, the 6G system will have 50 times higher simultaneous wireless communication connectivity than a 50 wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduce costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

The contents discussed above can be applied in combination with the methods proposed in the present disclosure, which will be described later, or can be supplemented to clarify the technical characteristics of the methods proposed in the present disclosure. The methods described below are divided for convenience of explanation, and it goes without saying that some components of one method may be replaced with some components of another method or may be applied in combination with each other.

Below, a method for improving reception reliability by alleviating performance degradation for channel estimation error will be discussed.

The symbols/abbreviations/terms used in the present disclosure are as follows.
DL: Deep Learning
NN: Neural Network

A learning procedure is required in DL-based communication systems. When this DL procedure is performed through online, a large overhead is required. For this reason, a method of using pre-generated NN parameters (e.g. DL parameters) using offline learning rather than online learning is being considered.

In the case of offline learning, learning is performed in advance, so it does not cause the overhead required in online learning, but since learning is not performed adaptively to the communication situation, flexibility depending on the channel state is reduced.

In order to solve these problems that occur in offline learning, it may be considered a method of performing learning according to the statistical characteristics of the channel rather than learning the deterministic channel coefficient during offline learning. Learning according to the statistical characteristics of a channel may be performed based on assumptions about specific statistical characteristics of the channel. As an example, learning according to the statistical characteristics of a channel can be performed assuming a channel environment that follows a Gaussian distribution in which a mean and variance have specific values.

However, if the statistical value of the channel considered in offline learning are different from the statistical value of the current channel, performance degradation of the communication system applying NN may occur. In this way, when 1) the statistical value of the input considered during learning and 2) the statistical value used for evaluation or detection are different, it is called a domain shift. When the domain shift occurs, performance deterioration of the corresponding neural network (e.g. DL NN) occurs.

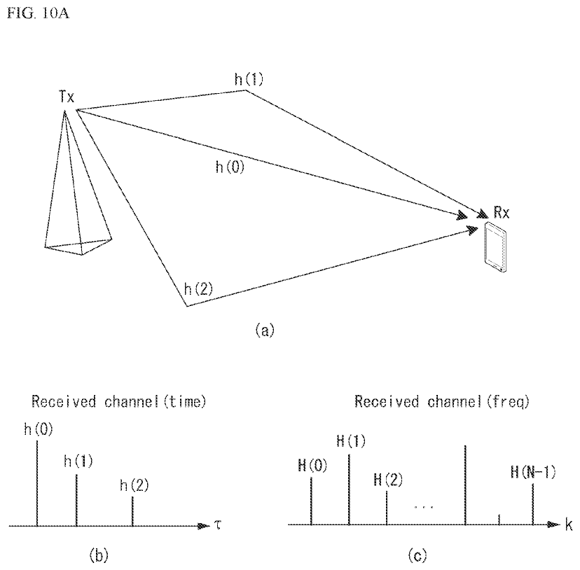

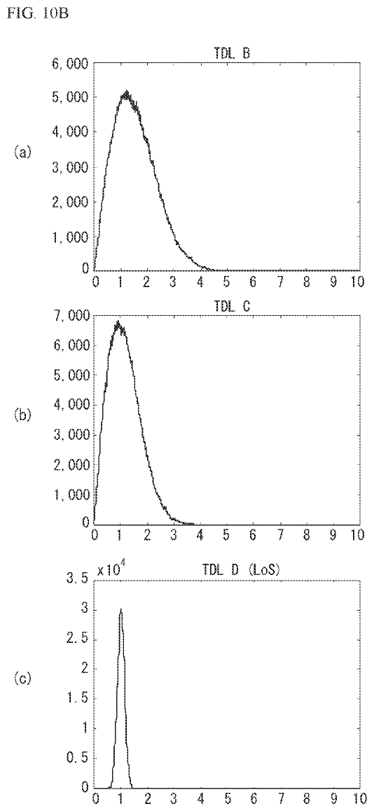

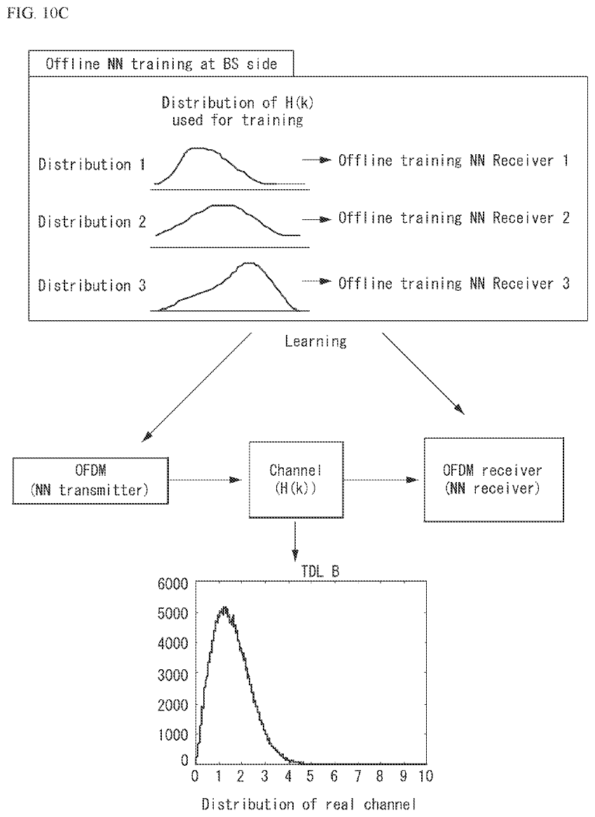

The above problem may become more severe in wireless environment channels with statistical characteristics. In order to utilize offline learning parameters (e.g. NN parameters) generated based on training that reflects the statistical characteristics of the channel, a parameter that matches the statistical characteristics of the current channel needs to be selected among the offline learning parameters. Contents related to the above-described problems will be described with reference to FIGS. 10A to 10C.

FIG. 10A is a diagram for explaining a channel environment of wireless communication.
(a) in FIG. 10A shows channels (h(0) to h(2)) between Tx/Rx.

When the channel (h) in the time domain is based on a complex Gaussian random variable ((b) in FIG. 10A), the channel (H) in the frequency domain can also be expressed as a complex Gaussian random variable ((c) in FIG. 10A).

FIG. 10B is a diagram illustrating a channel frequency response in a channel environment of wireless communication.

FIG. 10B shows a distribution of channel frequency response in a TDL (Tapped Delay Line) B/C/D channel environment. Referring to FIG. 10B, each channel environment has a different channel distribution ((a) to (c) of FIG. 10B). Therefore, operations according to the following 1) and 2) can be considered for selection of NN parameters.
1) Measurement of the current channel (e.g. complex Gaussian random variable with specific mean/variance)
2) Selection of NN parameters based on the above measurements

FIG. 10C is a diagram for explaining selection of NN parameters using channel distribution according to an embodiment of the present disclosure.

Referring to FIG. 10c, the distribution of the channels used when offline learning is performed for the NN of Tx/Rx is assumed to have the form of Distribution 1/2/3 (e.g. (a) to (c) of FIG. 10B). In order to apply appropriate NN Tx/Rx parameters at the time of communication, communication can be performed by applying NN parameters learned with the distribution closest to the distribution of the real channel.

Below, a method for applying NN parameters obtained from offline learning, which is performed by reflecting the statistical characteristics of the channel (statistical characteristics of the input), to the communication system is examined. Specifically, embodiments for selecting NN parameters suitable for the current channel environment include methods for channel statistics measurement and feedback, and selection of NN parameters based on the feedback.

Hereinafter, matters related to the notation of mathematical symbols in the present disclosure are as follows. Regular character represents scalar, bold lowercase character represents vector, bold uppercase character represents matrix, and Calligraphic character means a set. For example, x, x, X and X mean scalar, vector, matrix, and set, respectively. x[i] means to the ith entry of vector x and represents T[x[i]]ᵢ₌ₘⁿ=[x[m], x[m+1], . . . , x[n]]. |x| represents the absolute value of x.

Below, we look at CSI-related operations for determining NN parameters. Below, CSI-related operations for determining NN parameters are examined. Specifically, 1) CSI in the existing communication system and 2) CSI in the superimposed pilot system are examined.

Communication System without DL Applied

The receiving end (e.g. UE) feeds back channel state information (CSI) of the channel so that the transmitting end (e.g. base station) can determine the modulation coding scheme (MCS) level, etc. The transmitting end can use the feedback channel to determine the MCS level, precoding matrix, etc. CSI considered in the LTE/NR system may include Channel Quality Indicator (CQI), precoding matrix indicator (PMI), precoding type indicator (PTI), rank indication (RI), etc. CSI reporting (measurement and reporting operations related to CSI) may be performed periodically or aperiodically.

CSI in the existing system is for a communication system in which NN is not considered. It may not be easy to determine NN parameters through the information included in the existing CSI. Therefore, CSI that takes into account the communication system to which NN is applied is required.

In particular, when offline learning-based NN is applied, not only MCS and precoding information but also NN parameter selection must be considered, so when applying NN, channel information measurement and parameter selection and update methods suitable for parameter selection are required.

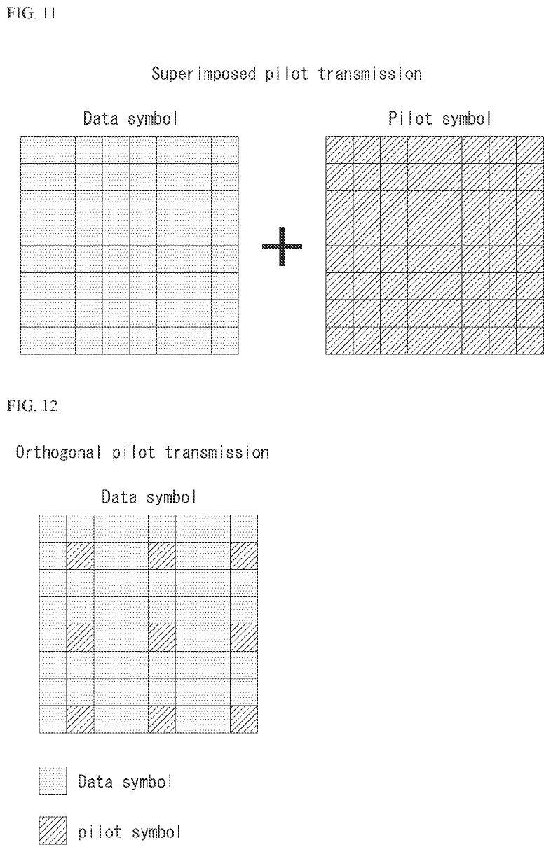

Hereinafter, the superimposed pilot system ill be described by comparing it with the existing system with reference to FIGS. 11 and 12.

### Superimposed Pilot System

FIG. 11 illustrates an OFDM system to which a superimposed pilot transmission method is applied. FIG. 12 illustrates an OFDM system to which an orthogonal pilot transmission method is applied.

According to the superimposed pilot transmission method (FIG. 11), pilot signals (e.g. Reference Signal, uplink RS, downlink RS) and data (e.g. UL/DL data) for channel estimation are transmitted based on the same resource. That is, the resource through which the pilot signal is transmitted and the resource through which data is transmitted completely superimposed with each other.

When the superimposed pilot transmission method is applied, orthogonal resources (i.e. non-superimposed resources) do not need to be allocated for transmission of the data symbol and pilot signal. In this respect, there is an advantage that more resources can be allocated for data symbol transmission. However, because the pilot signal and the data symbol are transmitted to be superimposed in the resource region, the pilot signal may act as interference during data decoding, resulting in performance degradation. In the case of the present method, since the pilot signal is transmitted from all resources, the influence of the frequency/time fading channel characteristics of the channel can be eliminated in determining the pilot position.

According to the orthogonal pilot transmission method (FIG. 12), pilot signals (e.g. reference signal, uplink RS, downlink RS) for channel estimation and data (e.g. UL/DL data) are transmitted based on orthogonal resources. While the present method is unlikely to cause performance degradation during data decoding, channel correlation must be considered to determine the position of the pilot symbol.

In the case of superimposed pilot transmission, the pilot signal is transmitted on all resources, so channel correlation does not need to be considered in the pilot signal resource allocation method.

Below, embodiments for determining NN parameters are described.

Channel Information Required when Selecting Parameters for NN Operating Based on Offline Learning

When NN training is performed by reflecting the statistical characteristics of the channel, distribution information of the channel is required rather than the instantaneous value of the channel to select NN parameters. Assuming that the characteristics of the channel have a complex Gaussian distribution, the probability distribution of the channel can be expressed as the mean and variance of the channel coefficients.

When the probability distribution of the channel is measured to select and use one of the NN parameters generated based on the training, since the instantaneous value of the channel is not used, there is no need to measure the probability distribution of the channel again unless the initial statistical characteristics of the channel change. Therefore, the frequency of NN parameter update can be reduced.

As an example, during offline learning, training can be performed assuming a channel environment that follows a complex Gaussian distribution with various means and variances. Among the probability distributions of the channel assumed when performing training, the NN parameters trained in the environment closest to the current channel environment can be selected/used.

At this time, if the data symbol and pilot signal are allocated to resources that are orthogonal to each other, performance varies depending on the time/frequency fading characteristics of the channel and the distribution of resources through which the pilot is transmitted. Since the time/frequency fading characteristics of the channel are added to the channel characteristics required when selecting NN parameters, the number of statistical characteristics of the channel to be considered increases.

Therefore, in order to exclude the problem that the number of cases related to the statistical characteristics of the channel increases depending on the resource allocation distribution of the pilot, a method of transmitting a pilot signal to all resources, such as a superimposed pilot transmission method, may be considered. When transmitting a pilot to all resources, statistical information that must be fed back can be reduced because subcarriers of different times and frequencies can be considered independently when measuring channel distribution.

Based on the superimposed pilot transmission method, time/frequency fading characteristics can be excluded from the statistical characteristics fed back. Accordingly, the payload size required to feed back information representing the statistical characteristics of the channel is reduced.

Although the description in the present disclosure focuses on the selection and update of Rx NN parameters (NN receiver), this proposed method is applicable not only to the NN parameters of Rx but also to the selection of NN parameters of Tx.

### Parameter Selection Procedure of NN Operating Based on Offline Learning

The parameter selection procedure of NN operating based on offline learning can be divided into the following operations.
1) Measure the probability distribution of the channel based on the pilot signal (e.g. UL/DL RS, superimposed pilot signal)
2) Calculate the gap (distance) between the measured channel probability distribution and the channel probability distribution considered during NN training. Select/determine the NN parameter to be used among the previously generated NN parameters based on the above calculation. Receive selected NN parameters from Tx (receive information including selected NN parameters from Tx).
3) Compare the probability distribution of the received signal (e.g. a signal related to data) with the previously measured probability distribution (e.g. a probability distribution measured based on the superimposed pilot signal or a probability distribution measured based on a previously received signal). If the difference between the probability distributions is equal to or greater than a threshold, the NN parameters are updated by re-performing the necessary parts of the operations according to 1) and 2) above. If the probability distribution of the channel is remeasured in 1) and update is not necessary, 2) and 3) are not performed.

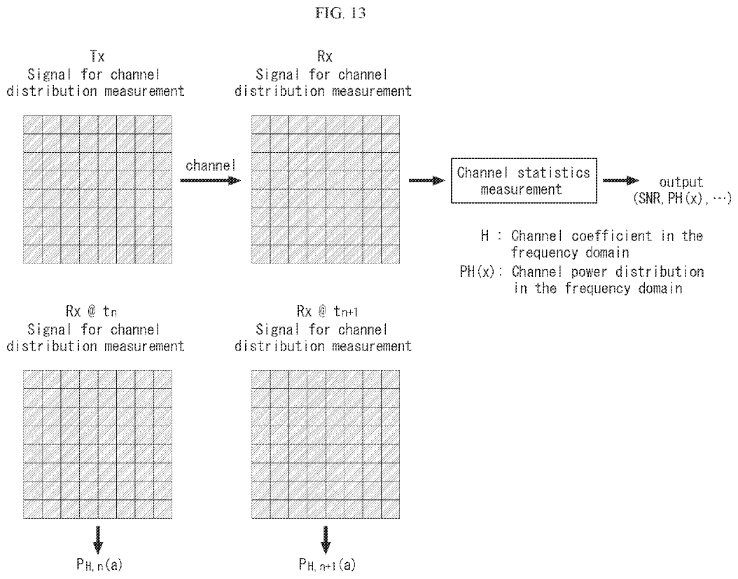

Hereinafter, the operations according to steps 1) to 3) described above will be described in more detail with reference to FIG. 13.

### Details of the Parameter Selection Procedure of NN Operating Based on Offline Learning

### 1) Step of Measuring Probability Distribution of Channel

FIG. 13 is a diagram for explaining a procedure for measuring probability distribution of a channel according to an embodiment of the present disclosure.

Referring to FIG. 13, Tx (e.g. transmitting end, base station) transmits a reference signal for measuring the probability distribution of the channel. As an example, the reference signal may be based on the superimposed pilot signal described above. Rx (e.g. receiving end, UE) measures the probability distribution of the channel based on the received reference signal. Additionally, statistical information on necessary channels, such as SNR, can also be obtained at the same time.

The channel probability distribution measurement may be stopped based on certain conditions being met. According to one embodiment, the certain condition may be configured to be satisfied when the difference between the previously measured channel distribution and the currently measured channel distribution is less than or equal to a certain threshold. When the above certain conditions are met, Rx (UE) stops measuring channel distribution. A metric for the difference in channel distribution may be based on any of Kullback-Leibler divergence, Wasserstein distance, or Kolmogorov-Smirnov statistic. However, the measurement metric for the channel distribution difference is not limited to the examples listed above, and other metrics defined for measuring the channel distribution difference may be used.

Below, the measurement of differences between channel distributions using Kullback-Leibler divergence is described.

A certain condition related to stopping the channel probability distribution measurement can be defined as Equation 1 or Equation 2 below using KL divergence.

$$KL ( {P}_{H , n} \vert \vert {P}_{H , n + 1} ) = {\sum }_{x} {P}_{H , n} ( x ) log ( \begin{matrix}{\underline{P}}_{\underline{H , n}} \underline{( x )} \\ {P}_{H , n + 1} ( x )\end{matrix} ) < ρ \qquad [ Equation 1 ]$$

$$KL ( {P}_{H , n} \vert \vert {P}_{H , n + 1} ) = {\sum }_{x} {P}_{H , n} ( x ) log ( \frac{{P}_{H , n + 1} ( x )}{{P}_{H , n} ( x )} ) < ρ \qquad [ Equation 2 ]$$

Here, P_{H,n} is the channel probability distribution measured in the nth measurement interval, and P_{H,n+1} is the channel probability distribution measured in the n+1th measurement interval. The channel probability distribution measurement may be configured to stop when the difference between the two probability distributions is less than a preconfigured threshold p.

Rx can stop measuring the channel probability distribution using conditions based on Equation 1 or Equation 2. According to one embodiment, Rx may request Tx to stop transmitting a reference signal for measuring the probability distribution of the channel.

### 2) Calculation of Gap (Distance) Between Probability Distributions and Determination of NN Parameters

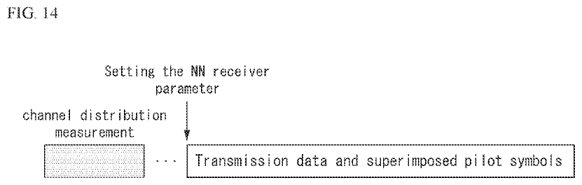

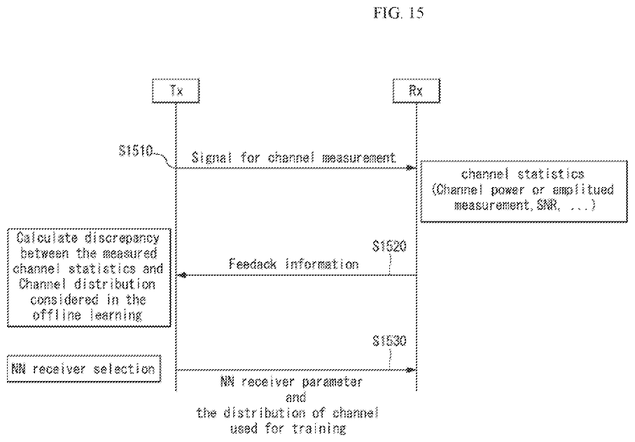

Rx calculates the gap (distance) between the measured channel probability distribution and the channel probability distribution considered during NN training. Based on the above calculation, the NN parameter to be used among the previously generated NN parameters may be selected/determined. Rx can receive the selected NN parameters from Tx (e.g. server, base station). Alternatively, Rx may receive information including the selected NN parameter from Tx. Hereinafter, it will be described with reference to FIG. 14.

FIG. 14 is a diagram for explaining NN parameters determined based on channel distribution measurement according to an embodiment of the present disclosure.

Referring to FIG. 14, NN parameters can be selected using channel distribution measurement. The selected NN parameter may be an NN receiver parameter for configuring a receiver for data communication.

Operations according to the above-described embodiments may be performed based on a procedure according to any one of Case 1 to Case 3, which will be described later. The procedures according to Case 1 to Case 3 above will be described with reference to FIGS. 15 to 17.

FIG. 15 is a flowchart showing an example of a procedure for configuring NN parameters according to an embodiment of the present disclosure.

Referring to FIG. 15, configuration of NN parameters can be performed based on S1510 to S1530.

In S1510, Tx (e.g. base station) transmits a signal for channel measurement to Rx (e.g. UE). Tx transmits channel distribution information considered in offline learning to Rx.

In S1520, Rx transmits feedback information to Tx.

According to one embodiment, the feedback information may include information indicating statistical characteristics of the channel (e.g. variance and mean in the case of a Gaussian distribution).

The feedback information may include at least one of information indicating statics related to channel power or amplitude, signal to noise ratio (SNR), information indicating other statistical characteristics, or receiver capability information of Rx.

The Tx that has received the feedback information can calculate the difference between the measured channel statics and channel distribution considered in the offline learning. At this time, the difference between the channel probability distributions can be calculated based on the measurement metric described above. The measurement metric may include Kullback-Leibler divergence, Wasserstein distance, or Kolmogorov-Smirnov statistic.

In S1530, Tx transmits NN parameters to Rx. Specifically, Tx can determine the NN parameter to be used by Rx based on the calculation result (i.e. the difference between the statistical characteristics of the measured channel and the channel distribution considered in offline learning). As an example, the NN parameter may be an NN receiver parameter applied to a receiver provided in Rx. Tx transmits the determined NN parameters (information including the determined NN parameters) to Rx.

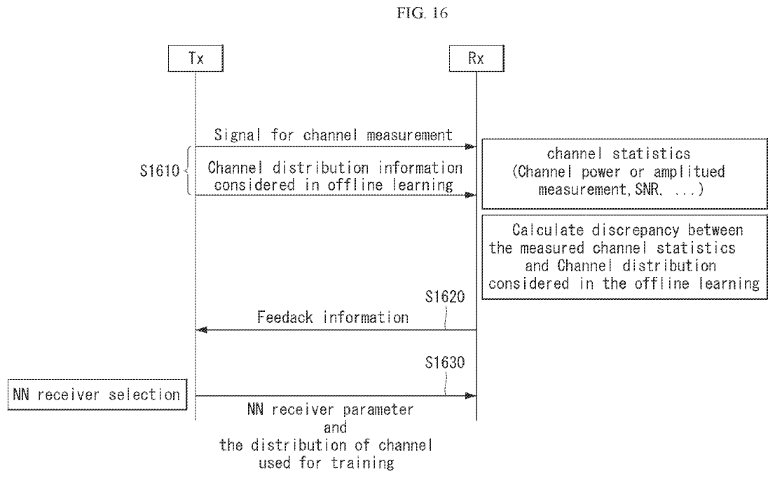

The difference between the statistical characteristics of the measured channel and the channel distribution considered in offline learning can also be calculated by Rx. Hereinafter, it will be described with reference to FIG. 16.

FIG. 16 is a flowchart showing another example of a procedure for configuring NN parameters according to an embodiment of the present disclosure. Hereinafter, descriptions of parts that overlap with those described in FIG. 15 will be omitted.

In S1610, Tx (e.g. base station) transmits a signal for channel measurement to Rx (e.g. UE). Tx transmits channel distribution information considered in offline learning to Rx.

According to one embodiment, the channel distribution information considered in offline learning may include information representing a preconfigured number of the channel probability distributions. The preconfigured number (S) of the channel probability distributions may include values representing mean (m) and variance (v) based on the preconfigured number. As an example, the preconfigured number (S) of the channel probability distributions can be expressed as follows.

Gaussian distribution with mean(m) and variance(v):(m₁,v₁),(m₂,v₂),(m₃,v₃), . . . ,(mₛ,vₛ)→S different Gaussian distributions

The sequence between transmission of the signal for channel measurement and transmission of information related to the channel distribution is not performed fixedly as shown in FIG. 16. For example, transmission of the signal for channel measurement and transmission of information related to the channel distribution considered in the offline learning may be performed independently. For example, transmission of information related to channel distribution considered in the offline learning may be performed before transmission of signals for channel measurement.

Rx may perform channel measurement based on the signal for the channel measurement and information related to the channel distribution considered in the offline learning. Measurement results may include information indicating statistical characteristics of the channel (e.g. power or amplitude, SNR, etc.).

Rx can calculate the difference between the measured channel statics and channel distribution considered in the offline learning. Rx may select one or more channel probability distributions from among the preconfigured number of channel probability distributions based on the calculated value.

In S1620, Rx transmits feedback information to Tx.

According to one embodiment, the feedback information may include information indicating statistical characteristics of the channel (e.g. variance and mean for Gaussian distribution). The feedback information may include probability distributions of the selected one or more channels.

In S1630, Tx transmits NN parameters to Rx. Specifically, Tx can determine the NN parameter to be used by Rx based on the feedback information. As an example, the NN parameter may be an NN receiver parameter applied to the receiver provided in the Rx. Tx transmits the determined NN parameters (information including the determined NN parameters) to Rx.

An example of a method of calculating the difference between probability distributions of channels using KL divergence in the above-described procedure will be described in detail below.

First, the sth probability distribution used during NN training is defined as Qs(x). If Qs(x) follows a Gaussian distribution, the mean and variance of the total S channel probability distributions are expressed as follows.

(m₁,v₁),(m₂,v₂),(m₃,v₃), . . . ,(mₛ,vₛ)→S different Gaussian distributions

The probability distribution of the measured channel (H) is defined as P_{H}(x). Using KL divergence between Qs(x) and P_{H}(x), the difference between the two probability distributions can be calculated based on Equation 3 or Equation 4 below.

$$KL ( {P}_{aH} \vert \vert {Q}_{s} ) = {\sum }_{x} {P}_{aH} ( x ) log ( \frac{{P}_{aH} ( x )}{{Q}_{s} ( x )} ) \qquad [ Equation 3 ]$$

$$KL ( {Q}_{s} \vert \vert {P}_{aH} ) = {\sum }_{x} {Q}_{s} ( x ) log ( \frac{{Q}_{s} ( x )}{{P}_{aH} ( x )} ) \qquad [ Equation 4 ]$$

Here, a is a scalar factor applied to the channel when measuring the channel probability distribution. Therefore, KL divergence is calculated according to the index s and scale a values of Q.

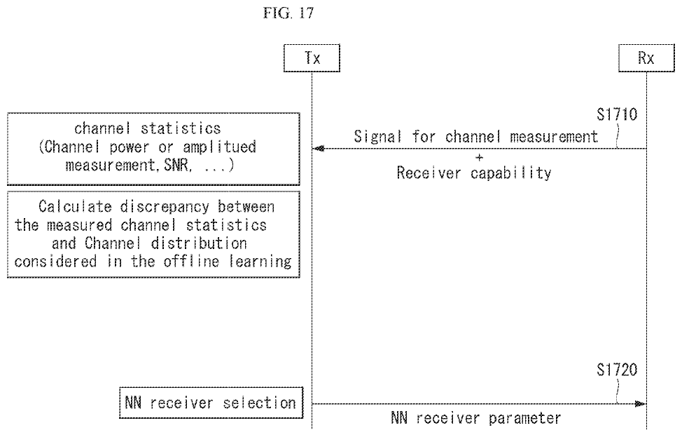

The signal for channel measurement described above in FIGS. 15 and 16 may be transmitted by Rx (e.g. UE) using NN parameters. Hereinafter, it will be described in detail with reference to FIG. 17.

FIG. 17 is a flowchart showing another example of a procedure for configuring NN parameters according to an embodiment of the present disclosure. Hereinafter, descriptions of parts that overlap with those described in FIGS. 15 and 16 will be omitted.

In S1710. Rx (e.g. UE) transmits a signal for channel measurement to Tx (e.g. base station). At this time, the Rx can transmit the receiver capability information of the corresponding Rx to the Tx.

Tx may perform channel measurement based on the signal for the channel measurement and information related to the channel distribution considered in offline learning. The measurement results may include information indicating statistical characteristics of the channel (e.g. power or amplitude, SNR, etc.).

Tx can calculate the difference between the measured channel statics and channel distribution considered in the offline learning.

S1720 is the same as S1530, so duplicate descriptions are omitted.

### 3) Update of NN Parameters

Update of NN parameters may be performed based on comparison between i) the probability distribution of the received signal (e.g. probability distribution measured based on the pilot signal, signal related to data) and ii) the previously measured probability distribution (e.g. a probability distribution measured based on previously received signals).

If the difference between probability distributions is equal to or greater than a threshold value, among the operations described above for 1) measuring the channel probability distribution and 2) calculating the gap (distance) between the probability distributions and determining NN parameters, the necessary operations can be re-performed and the NN parameters can be updated.

In 1), if the probability distribution of the channel is remeasured and no update is required (e.g. when the difference between probability distributions is less than a threshold value), operations according to 2) and 3) above may not be performed. Below, methods for updating NN parameters are examined in detail.

### Method 1

When the difference between i) the channel probability distribution measured from the currently received signal and ii) the channel probability distribution measured from the previously received signal is equal to or greater than a certain threshold, one or more of the operations according to 1) and 2) above may be performed again and the NN parameters can be updated.

The received signal can be defined as follows.

Received signal:y_{m,k}=H_{m,k}(X_{m,k}+P_{m,k})+W_{m,k}

Here, H_{m,k} is a channel coefficient, X_{m,k} is a data symbol, P_{m,k} is a pilot symbol, and W_{m,k} is an Additive White Gaussian noise (AWGN noise).

When using KL divergence, the difference between i) the channel probability distribution measured from the currently received signal and ii) the channel probability distribution measured from the previously received signal is calculated based on Equation 5 or Equation 6 below.

$$KL ( {P}_{{y}_{t}} \vert \vert {P}_{{y}_{t + 1}} ) = {\sum }_{x} {P}_{{y}_{t}} ( x ) log {( \frac{{P}_{{y}_{t}} ( x )}{{P}_{{y}_{t + 1}} ( x )} )}_{H , n} \geq Threshold \qquad [ Equation 5 ]$$

$$KL ( {P}_{{y}_{t + 1}} \vert \vert {P}_{{y}_{t}} ) = {\sum }_{x} {P}_{{y}_{t + 1}} ( x ) log {( \frac{{P}_{{y}_{t + 1}} ( x )}{{P}_{{y}_{t}} ( x )} )}_{H , n} \geq Threshold \qquad [ Equation 6 ]$$

Here, P_{y}_{ₜ} and P_{y}_{ₜ₊₁} mean the channel probability distribution of the signal received in the t reception interval and the channel probability distribution of the signal received in the t+1 reception interval, respectively.

### Method 2

When the difference between i) the channel probability distribution measured from the currently received signal and ii) the channel probability distribution of predicted received signals is greater than a certain threshold, one or more of the operations according to 1) and 2) above may be performed again and the NN parameters can be updated. The specific threshold according to the present embodiment may be configured as a different value from the specific threshold of Method 1 above.

The present embodiment can be applied when the channel probability distribution can be expressed by a formula such as a Gaussian distribution.

The probability distribution of the received signal y_{m,k}(=H_{m,k}(X_{m,k}+P_{m,k})+W_{m,k}) is expressed as a joint distribution of the H, X, P, and W probability distributions. Here, W is the AWGN noise, and given the SNR, the probability distribution of W can be determined. Additionally, it can be assumed that the probability distribution of the transmission signal and pilot (X_{m,k}, P_{m,k}) is known. Therefore, if the probability distribution of H can be expressed in a formula, the probability distribution of y can be calculated.

The predicted value \hat{P}_{y}(x) of the probability distribution of the received signal can be calculated using the probability distribution and noise power of the measured channel when selecting currently used NN parameters. Therefore, the difference between i) the channel probability distribution P_{y}(x) measured from the currently received signal and ii) the channel probability distribution \hat{P}_{y}(x) of the predicted received signal can be defined as KL(\hat{P}_{y}∥P_{y}) or KL(P_{y}∥\hat{P}_{y}).

If the KL(\hat{P}_{y}∥P_{y}) or KL(P_{y}∥\hat{P}_{y}) is greater than a certain threshold, one or more of the operations according to 1) and 2) above may be performed again and the NN parameter may be updated.

If the channel or noise environment does not change significantly (i.e., if KL(\hat{P}_{y}∥P_{y}) or KL(P_{y}∥\hat{P}_{y}) is less than the specific threshold above), no operation (operations according to 1) and 2) above) is performed to update NN parameters.

If the noise power is measured using a superimposed pilot received from the same resource as the data, the probability distribution of W when calculating PP may consider the noise power of the currently received signal rather than the measured value when selecting the NN parameter. KL(\hat{P}_{y}∥P_{y}) or KL(P_{y}∥\hat{P}_{y}) becomes a value that increases as the difference between the probability distributions of channels increases.

In terms of implementation, operations (e.g. operations related to determination of NN parameters) according to the above-described embodiments can be processed by the devices (e.g. processors 202a and 202b in FIG. 2) of FIGS. 1 to 5 described above.

Additionally, operations (e.g. operations related to determination of NN parameters) according to the above-described embodiments may be stored in memory (e.g. 204a, 204b in FIG. 2) in the form of instructions/programs (e.g. instruction, executable code) for driving at least one processor (e.g. processors 202a and 202b in FIG. 2).

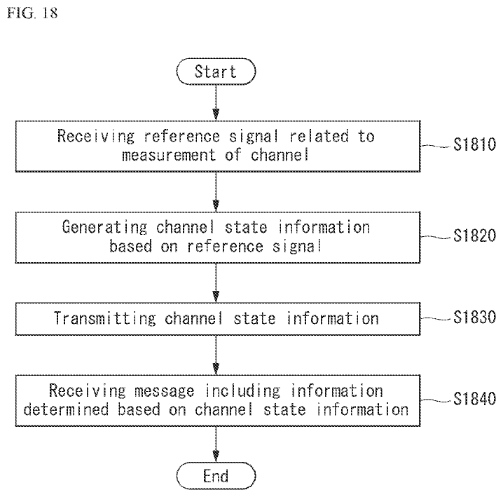

Hereinafter, the above-described embodiments will be described in detail with reference to FIG. 18 in terms of the operation of a wireless device (e.g. the first wireless device 200a and the second wireless device 200b in FIG. 2). The methods described below are divided for convenience of explanation, and it goes without saying that some components of one method may be replaced with some components of another method or may be applied in combination with each other.

FIG. 18 is a flowchart illustrating a method of transmitting channel state information performed by a user equipment (UE) according to an embodiment of the present disclosure.

Referring to FIG. 18, a method of transmitting channel state information performed by a user equipment (UE) according to an embodiment of the present disclosure includes receiving a reference signal related to measurement of a channel (S1810), generating channel state information based on the reference signal (S1820), transmitting the channel state information (S1830), and receiving a message including information determined based on channel state information (S1840).

In S1810, the UE receives the reference signal related to the measurement of the channel from a base station. The reference signal related to the measurement of the channel may be based on a downlink reference signal (DL RS). The DL RS may be based on at least one of a synchronization signal block (SSB) or channel state information-reference signal (CSI-RS).

According to the above-described S1810, the operation of receiving the reference signal related to the measurement of the channel by the UE (e.g. 200a in FIG. 2) from the base station (e.g. 200b in FIG. 2) can be implemented by the device of FIGS. 1 to 5. For example, referring to FIG. 2, one or more processors 202a may control one or more transceivers 206a and/or one or more memories 204a to receive the reference signal related to the measurement of the channel from the base station (e.g. 200b in FIG. 2).

In S1820, the UE generates channel state information based on the reference signal.

According to the above-described S1820, the operation of generating channel state information by the UE (e.g. 200a in FIG. 2) based on the reference signal can be implemented by the device of FIGS. 1 to 5. For example, referring to FIG. 2, one or more processors 202a may control one or more transceivers 206a and/or one or more memories 204a to generate channel state information based on the reference signal.

In S1830, the UE transmits the channel state information to the base station.

According to one embodiment, the channel state information may include at least one of 1) information related to probability distributions based on the measurement of the channel or 2) information related to the difference between the probability distribution used for learning of the Neural Network (NN) related to the wireless communication system and the probability distribution based on the measurement of the channel. The channel state information may be based on the feedback information of FIGS. 15 and 16.

According to one embodiment, a specific value related to the update of the NN parameter may be determined by a probability distribution based on the measurement of the channel. The specific value may be a reference value for determining whether to perform an operation related to updating NN parameters.

Specifically, the specific value may be based on i) the difference between the probability distribution based on measurements of the channel obtained based on the current time and the probability distribution based on measurements of the channel previously obtained based on a previous time or ii) the difference between the probability distribution based on measurements of the channel obtained based on the current time and the estimated value of the probability distribution related to the channel. The specific value based on i) may be based on Method 1, and the specific value based on ii) may be based on Method 2.

Based on the specific value being greater than or equal to a preconfigured value, the method may be performed again from any one of steps S1810 to S1830.

According to one embodiment, the information related to the probability distribution based on the measurement of the channel may include information related to at least one of i) received power of the reference signal or ii) Signal to Noise Ratio (SNR).

According to one embodiment, based on the reference signal being related to a superimposed pilot signal transmitted in a same resource region as data, a number of cases due to fading related to a resource region in which the reference signal is transmitted may be excluded from a number of cases related to the probability distribution based on the measurement of the channel. According to the present embodiment, the payload size of channel state information is reduced, so the signaling overhead of the procedure for determining NN parameters can be improved.

According to one embodiment, based on information on the probability distribution used for learning a neural network (NN) related to the wireless communication system being preconfigured, 1) the information on the probability distribution used for learning a neural network (NN) related to the wireless communication system may include a preconfigured number of probability distributions, and 2) the channel state information may include one or more probability distributions among the preconfigured number of probability distributions. The present embodiment may be based on S1620 of FIG. 16.

According to the above-described S1830, the operation of transmitting the channel state information by the UE (e.g. 200a in FIG. 2) to the base station (e.g. 200b in FIG. 2) can be implemented by the devices of FIGS. 1 to 5. For example, referring to FIG. 2, one or more processors 202a may control one or more transceivers 206a and/or one or more memories 204a to transmit the channel state information to the base station (e.g. 200b in FIG. 2).

In S1840, the UE receives a message including information determined based on the channel state information from the base station. The operation according to S1840 may be based on at least one of S1530 of FIG. 15, S1630 of FIG. 16, or S1720 of FIG. 17.

According to one embodiment, the information determined based on the channel state information may include neural network (NN) parameters applied to the neural network.

According to one embodiment, the message including information determined based on the channel state information may be based on any one of downlink control information (DCI), medium access control-control element (MAC-CE), or RRC message. As an example, a message including information determined based on the channel state information may be based on downlink control information (DCI) that schedules a physical downlink shared channel (PDSCH).

According to one embodiment, the NN parameter may be related to at least one of the configuration of an NN receiver or NN transmitter that operates based on a neural network (NN) related to the wireless communication system. At this time, the UE can receive data from the base station based on the NN receiver to which the NN parameter is applied. The data may be related to a PDSCH scheduled by a message (e.g. DCI) including information determined based on the channel state information.

According to the above-described S1840, the operation of receiving a message including information determined based on the channel state information by the UE (e.g. 200a in FIG. 2) from the base station (e.g. 200b in FIG. 2) can be implemented by the devices of FIGS. 1 to 5. For example, referring to FIG. 2, one or more processors 202a may control one or more transceivers 206a and/or one or more memories 204a to receive a message including information determined based on the channel state information from a base station (e.g. 200b in FIG. 2).

Although the method according to the above-described embodiments has been described with a focus on the operation of the UE, application of the method based on the embodiments of the present disclosure is not limited to the operation of the UE. As an example, a method based on embodiments of the present disclosure may be applied to the operation of the base station. Specifically, the method based on the above-described embodiments can be applied to a method for receiving the channel state information performed by the base station. Below is a detailed explanation excluding duplicate content.

A method of receiving channel state information performed by a base station according to another embodiment of the present disclosure may include a first step of transmitting a reference signal related to measurement of a channel, a second step of receiving channel state information generated based on the reference signal, and a third step of transmitting a message including information determined based on the channel state information.

In the first step, the base station transmits the reference signal related to the measurement of the channel to the UE.

According to the above-described first step, the operation of transmitting the reference signal related to the measurement of the channel by the base station (e.g. 200b in FIG. 2) to the UE (e.g. 200a in FIG. 2) can be implemented by the device of FIGS. 1 to 5. For example, referring to FIG. 2, one or more processors 202b may control one or more transceivers 206b and/or one or more memories 204b to transmit the reference signal related to the measurement of the channel to the UE (e.g. 200a of FIG. 2).

In the second step, the base station receives the channel state information generated based on the reference signal from the UE.

According to the above-described second step, the operation of receiving channel state information generated based on the reference signal by the base station (e.g. 200b in FIG. 2) from the UE (e.g. 200a in FIG. 2) may be implemented by the devices of FIGS. 1 to 5. For example, referring to FIG. 2, one or more processors 202b may control one or more transceivers 206b and/or one or more memories 204b to receive the channel state information generated based on the reference signal from the UE (e.g. 200a in FIG. 2).

In the third step, the base station transmits a message including information determined based on the channel state information to the UE. Information determined based on the channel state information may include neural network (NN) parameters applied to the neural network.

At this time, a downlink shared channel (PDSCH) for the UE may be scheduled based on a message (e.g. DCI) including information determined based on the channel state information. Based on the PDSCH scheduled by the DCI, the base station can transmit data to the UE. The UE can receive the data from the base station based on the NN receiver to which the NN parameter is applied.

According to the third step described above, the operation of transmitting a message including information determined based on the channel state information by the base station (e.g. 200b in FIG. 2) to the UE (e.g. 200a in FIG. 2) may be implemented by the devices of FIGS. 1 to 5. For example, referring to FIG. 2, one or more processors 202b may control one or more transceivers 206b and/or one or more memories 204b to transmit a message including information determined based on the channel state information to the UE (e.g. 200a in FIG. 2).

Here, the wireless communication technology implemented in the device (200a, 200b) of the present disclosure may include LTE, NR, and 6G as well as Narrowband Internet of Things (NB-IoT) for low-power communication. For example, the NB-IoT technology may be an example of a LPWAN (Low Power Wide Area Network) technology, and may be implemented in standards such as LTE Cat NB1 and/or LTE Cat NB2, and is not limited to the above-described name. Additionally or alternatively, the wireless communication technology implemented in the device (200a, 200b) of the present disclosure may perform communication based on the LTE-M technology. For example, the LTE-M technology may be an example of LPWAN technology, and may be called by various names such as enhanced machine type communication (eMTC). For example, LTE-M technology may be implemented in at least one of various standards such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described name. Additionally or alternatively, the wireless communication technology implemented in the device (200a, 200b) of the present disclosure may include at least one of ZigBee, Bluetooth, and Low Power Wide Area Network (LPWAN) in consideration of low power communication, and is not limited to the above-described name. For example, the ZigBee technology may generate PAN (personal area networks) related to small/low-power digital communication based on various standards such as IEEE 802.15.4, and may be called by various names.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by subsequent amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. For example, software code may be stored in a memory unit and executed by a processor. The memories may be located at the interior or exterior of the processors and may transmit data to and receive data from the processors via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

1. A method of transmitting channel state information performed by a user equipment (UE) in a wireless communication system, comprising:
a first step of receiving a reference signal related to measurement of a channel;
a second step of generating channel state information based on the reference signal;
a third step of transmitting the channel state information; and
a fourth step of receiving a message including information determined based on the channel state information,
wherein the channel state information includes at least one of 1) information related to a probability distribution based on the measurement of the channel or 2) information related to a difference between a probability distribution used for learning a neural network (NN) related to the wireless communication system and the probability distribution based on the measurement of the channel, and
wherein the information determined based on the channel state information includes a neural network (NN) parameter applied to the neural network.

2. The method of claim 1, wherein a specific value related to update of the NN parameter is determined by the probability distribution based on the measurement of the channel.

3. The method of claim 2, wherein the specific value is based on i) a difference between a probability distribution based on the measurement of the channel obtained based on a current time and a probability distribution based on the measurement of the channel previously obtained based on a previous time or ii) a difference between the probability distribution based on the measurement of the channel obtained based on the current time and an estimated value of a probability distribution related to the channel.

4. The method of claim 3, wherein, based on the specific value being greater than or equal to a preconfigured value, the method is performed again from any one of the first to third steps.

5. The method of claim 1, wherein the information related to the probability distribution based on the measurement of the channel includes information related to at least one of i) received power of the reference signal or ii) a signal to noise ratio (SNR).

6. The method of claim 1, wherein, based on the reference signal being related to a superimposed pilot signal transmitted in a same resource region as data,
wherein a number of cases due to fading related to a resource region in which the reference signal is transmitted is excluded from a number of cases related to the probability distribution based on the measurement of the channel.

7. The method of claim 1, wherein the NN parameter is related to configuration of at least one of an NN receiver or NN transmitter that operates based on a neural network (NN) related to the wireless communication system.

8. The method of claim 7, further comprising:
receiving data based on the NN receiver to which the NN parameter is applied.

9. The method of claim 1, wherein, based on information on the probability distribution used for learning the neural network (NN) related to the wireless communication system being preconfigured:
1) the information on the probability distribution used for learning the neural network (NN) related to the wireless communication system includes a preconfigured number of probability distributions, and
2) the channel state information includes one or more probability distributions among the preconfigured number of probability distributions.

10. A user equipment (UE) transmitting channel state information in a wireless communication system, comprising:
one or more transceivers;
one or more processors controlling the one or more transceivers; and
one or more memories operably connected to the one or more processors, and storing instructions that configure the one or more processors to perform operations when being executed by the one or more processors,
wherein the operations include:
a first step of receiving a reference signal related to measurement of a channel;
a second step of generating channel state information based on the reference signal;
a third step of transmitting the channel state information; and
a fourth step of receiving a message including information determined based on the channel state information,
wherein the channel state information includes at least one of 1) information related to a probability distribution based on the measurement of the channel or 2) information related to a difference between a probability distribution used for learning a neural network (NN) related to the wireless communication system and the probability distribution based on the measurement of the channel, and
wherein the information determined based on the channel state information includes a neural network (NN) parameter applied to the neural network.

11-13. (canceled)

14. A base station receiving channel state information in a wireless communication system, comprising:
one or more transceivers;
one or more processors controlling the one or more transceivers; and
one or more memories operably connected to the one or more processors, and storing instructions that configure the one or more processors to perform operations when being executed by the one or more processors,
wherein the operations include:
transmitting a reference signal related to measurement of a channel;
receiving channel state information generated based on the reference signal; and
transmitting a message including information determined based on the channel state information,
wherein the channel state information includes at least one of 1) information related to a probability distribution based on the measurement of the channel or 2) information related to a difference between a probability distribution used for learning a neural network (NN) related to the wireless communication system and the probability distribution based on the measurement of the channel, and
wherein the information determined based on the channel state information includes a neural network (NN) parameter applied to the neural network.
